(19) United States
(12) Patent Application Publication
(10) Pub. No.: US 2026/0312466 A1
(43) Pub. Date: Oct. 8, 2026

(54) ENGINE COOLING FAN MOTOR FOR VEHICLE

(71) Applicant: NEW MOTECH CO., LTD., Gwangju (KR)

(72) Inventors: Jeong Cheol JANG, Gwangju (KR); Min Ho KIM, Gwangju (KR); Pan Guk PARK, Gwangju (KR)

(73) Assignee: NEW MOTECH CO., LTD., Gwangju (KR)

(21) Appl. No.: 19/481,869

(22) PCT Filed: May 14, 2024
(86) PCT No.: PCT/KR2024/006568

§ 371 Date: Nov. 5, 2025

(30) Foreign Application Priority Data
Jul. 11, 2023 (KR) 10-2023-0089570

(51) Int. Cl. H02K 9/22; F04D 25/06; F04D 29/58; H02K 1/14; H02K 3/32; H02K 7/08; H02K 11/33; H02K 21/22

(52) U.S. Cl. CPC H02K 9/223; F04D 25/06; F04D 29/584; H02K 1/146; H02K 3/325; H02K 7/085; H02K 11/33; H02K 21/22; H02K 2211/03

(57) ABSTRACT

The engine cooling fan motor for a vehicle according to the present invention comprises: an upper housing 100 having a PCB 110 housed therein; and a motor assembly 200 comprising a rotor assembly 10 coupled to a shaft 11 rotating through an upper bearing 11A and a lower bearing 11B, comprising a rotor housing 13 provided with a plurality of magnets 12 along an inner periphery; and a stator assembly 20 assisting the rotation of the rotor assembly 10; wherein the stator assembly 20 is insert injected with a resin to enclose the stator assembly 20 with a molding 210, and a plurality of heat dissipating parts 211 are formed at regular intervals in the transverse direction on an upper part and a lower part of the molding 210 to dissipate the heat generated inside the stator assembly 20.

### TECHNICAL FIELD

The present invention relates to an engine cooling fan motor for a vehicle. More specifically, the present invention relates to an engine cooling fan motor for a vehicle capable of improving the cooling efficiency of the motor and improving the performance of the motor by rapidly dissipating heat generated inside the motor.

### BACKGROUND ART

In general, the engine room of a vehicle is provided with an engine, which is a driving unit, a cooling means for preventing the engine from overheating, and an air conditioning means having an air conditioning function for the occupant space inside the vehicle, and a cooling fan is installed on one side of the radiator to activate the heat exchange action of the radiator. The cooling fan is driven by a cooling fan motor.

Such a cooling fan motor is disclosed in Korean Patent No. 10-0645797. The prior art comprises a front cover, a rotor shaft comprising a stator core provided inside the front cover, on which a coil is wound, and a permanent magnet, a back cover fastened to one side of the front cover, and a PCB plate applying current to the stator core. A heat dissipation groove for cooling the motor is formed in the front cover so that the heat generated from the furnace part mounted on the PCB plate is discharged through the heat dissipation groove, thereby increasing the efficiency of the motor. However, the heat generated by the coils wound on the stator may cause the motor to malfunction and reduce the performance of the motor. In addition, the contact between the coils wound on each of the stator cores may cause short circuits, causing damage to the motor and shortening its lifespan.

In order to solve the above problems, the present invention suggests a novel type of engine cooling fan motor for a vehicle of capable of efficiently dissipating the heat generated by the motor.

### DISCLOSURE OF INVENTION

### Technical Problem

It is an object of the present invention to provide an engine cooling fan motor capable of preventing contact between coils wound on a stator core and rapidly dissipating heat generated from a stator assembly, thereby improving the performance of the motor.

The above and other inherent objects of the present invention may all be easily achieved by the description of the present invention described below.

### Solution to Problem

The engine cooling fan motor for a vehicle according to the present invention comprises: an upper housing 100 having a PCB 110 housed therein; and a motor assembly 200 comprising a rotor assembly 10 coupled to a shaft 11 rotating through an upper bearing 11A and a lower bearing 11B, comprising a rotor housing 13 provided with a plurality of magnets 12 along an inner periphery; and a stator assembly 20 assisting the rotation of the rotor assembly 10; wherein the stator assembly 20 is insert injected with a resin to enclose the stator assembly 20 with a molding 210, and a plurality of heat dissipating parts 211 are formed at regular intervals in the transverse direction on an upper part and a lower part of the molding 210 to dissipate the heat generated inside the stator assembly 20.

In the present invention, preferably, the molding 210 is molded with a resin on an upper part, lower part, inner side and outer side of an aluminum coil C including the teeth 21′, 22′, 23′ of each of the first to third segmented laminated cores 21, 22, 23.

In the present invention, preferably, the molding 210 has a plurality of heat dissipating parts 211 which have the outer side open and form a heat dissipating space S of a ‘V’shape in which the inner side is narrow and the outer side is wide.

In the present invention, preferably, a concaved-shape heat dissipating protrusion 211A protrudes longitudinally on both inner sides of the heat dissipating space S of each of the plurality of the dissipating parts 211 formed on the molding 210.

In the present invention, preferably, an aluminum heat dissipating plate 211C having a plurality of heat dissipating holes 211C′ is axially inserted into a guide rail 211B axially formed on both inner sides of the heat dissipating space S of each of the plurality of heat dissipating parts 211 formed on the molding 210.

In the present invention, preferably, the stator assembly 20 is assembled by winding an aluminum coil C on each neck part 21″, 22″, 23″ of the first to third segmented laminated cores 21, 22, 23 in which a plurality of teeth 21′, 22′, 23′ are protruded at equal intervals.

### Advantageous Effects of Invention

The present invention has the effect of improving the quality of the motor, securing safety, and extending the life of the motor by excluding short circuits between the aluminum coils by insert injecting a stator assembly with a resin and enclosing the stator assembly with a molding.

The present invention has the effect of improving the cooling efficiency of the motor by dissipating the heat generated inside the motor through a plurality of heat dissipating parts formed in a molding, thereby improving the performance of the motor.

### BRIEF DESCRIPTION OF DRAWINGS

FIG. 1 is a perspective view illustrating an engine cooling fan motor for a vehicle according to the present invention;

FIG. 2 is an exploded perspective view illustrating an engine cooling fan motor for a vehicle according to the present invention;

FIG. 3 is a cross-sectional view illustrating an engine cooling fan motor for a vehicle according to the present invention;

FIG. 4 is a perspective view illustrating a motor assembly of an engine cooling fan motor for a vehicle according to the present invention;

FIG. 5 is a cut-away perspective view illustrating a motor assembly of an engine cooling fan motor for a vehicle according to the present invention;

FIG. 6 is a cross-sectional view illustrating a motor assembly of an engine cooling fan motor for a vehicle according to the present invention;

FIG. 7 is a cross-sectional view illustrating an excerpted portion of another embodiment of a motor assembly of an engine cooling fan motor for a vehicle according to the present invention;

FIG. 8 is a cross-sectional view illustrating an excerpted portion of yet another embodiment of a motor assembly of an engine cooling fan motor for a vehicle according to the present invention;

FIG. 9 is an exploded perspective view illustrating a stator assembly according to the present invention; and

FIG. 10 is a perspective view illustrating a stator assembly according to the present invention.

Hereinafter, the present invention will be described in detail with reference to the accompanying drawings.

### MODE FOR THE INVENTION

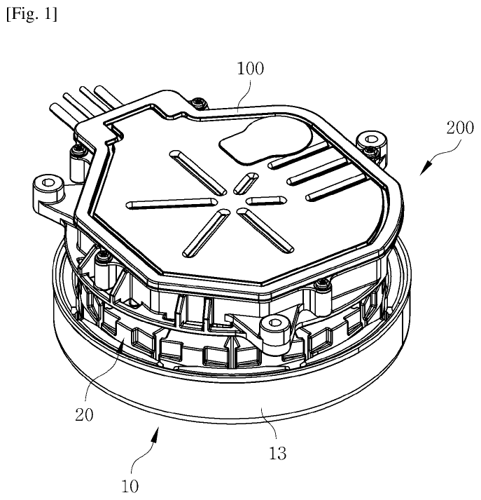

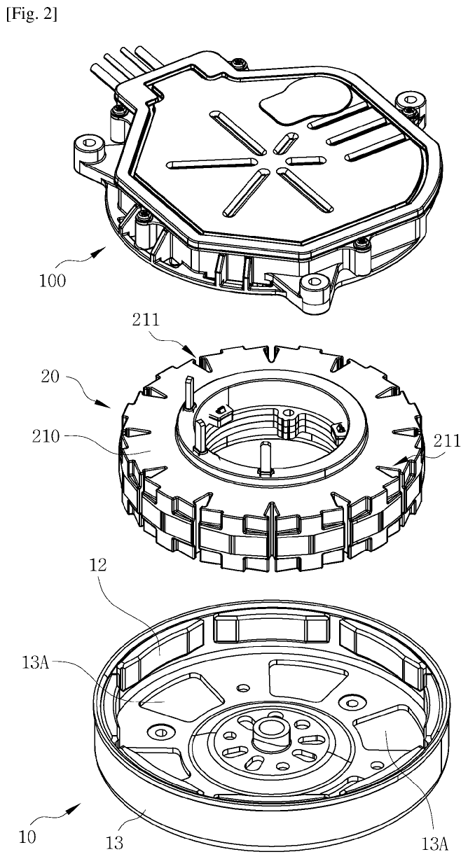

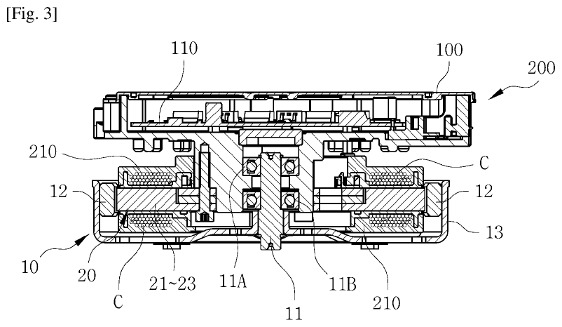

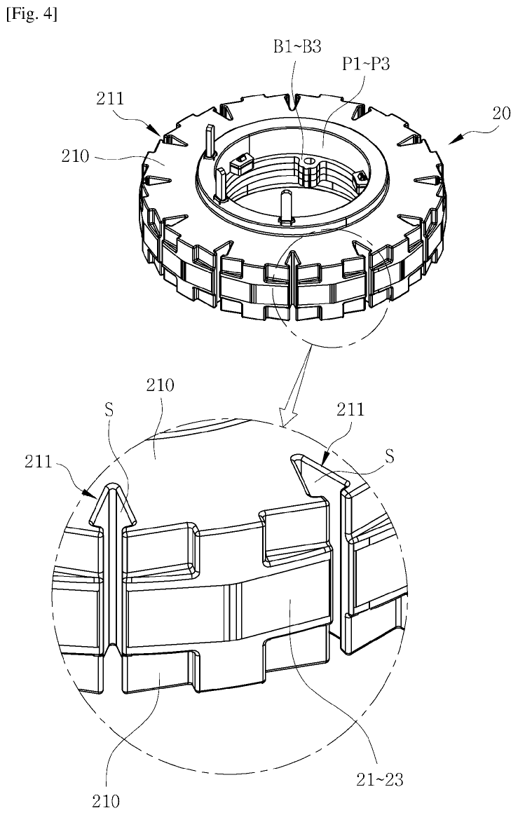

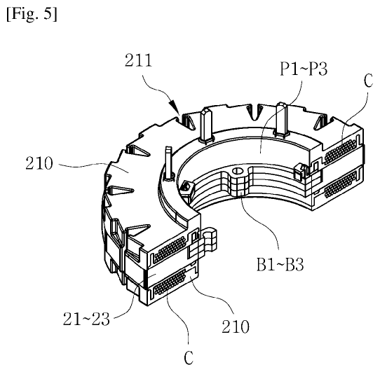

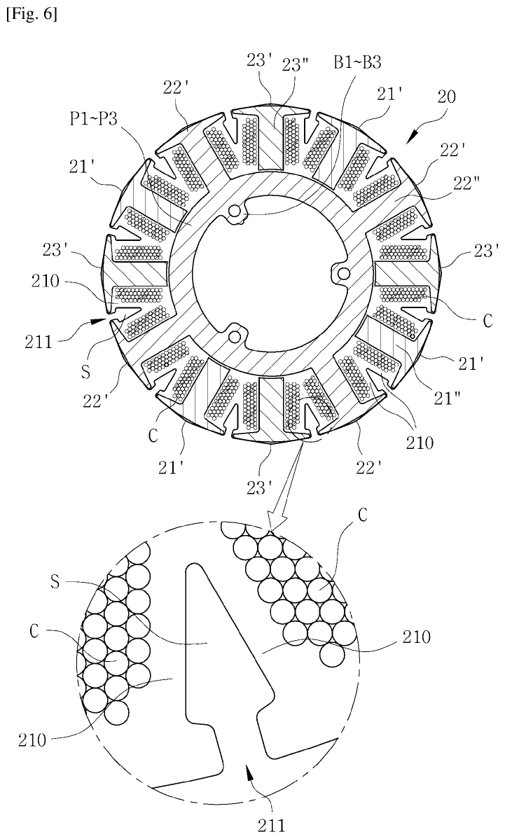

FIG. 1 is a perspective view illustrating an engine cooling fan motor for a vehicle according to the present invention. FIG. 2 is an exploded perspective view illustrating an engine cooling fan motor for a vehicle according to the present invention. FIG. 3 is a cross-sectional view illustrating an engine cooling fan motor for a vehicle according to the present invention. FIG. 4 is perspective view illustrating a motor assembly of an engine cooling fan motor for a vehicle according to the present invention. FIG. 5 is a cut-away perspective view illustrating a motor assembly of an engine cooling fan motor for a vehicle according to the present invention. FIG. 6 is a cross-sectional view illustrating a motor assembly of an engine cooling fan motor for a vehicle according to the present invention.

As illustrated in FIGS. 1 to 6, the engine cooling fan motor for a vehicle according to the present invention comprises an upper housing 100 having a printed circuit board (PCB) 110 housed therein, and a motor assembly 200 comprising a rotor assembly 10 coupled to a shaft 11 rotating through an upper bearing 11A and a lower bearing 11B, comprising a rotor housing 13 provided with a plurality of magnets 12 along an inner periphery, and a stator assembly 20 assisting the rotation of the rotor assembly 10. An outer periphery of the stator assembly 20 is press-fit against an inner surface of a plurality of magnets 12 disposed on an inner periphery of the rotor housing 13.

As illustrated in FIGS. 2 to 6, the stator assembly 20 is insert injected with a bulk molding compound (BMC) resin to enclose the stator assembly 20 with a molding 210. The molding 210 is a molded body filled with a resin on the outer side of an aluminum coil C comprising neck parts 21″, 22″, 23″ of the teeth 21′, 22′, 23′ of each of first to third segmented laminated cores 21, 22, 23 configuring the stator assembly 20, which secures safety by excluding short circuits between the aluminum coils C. Accordingly, the quality of the motor may be improved, and the life of the motor may be extended. In addition, by providing the coil as an aluminum coil C, a motor is provided which is light in weight and may lower manufacturing costs.

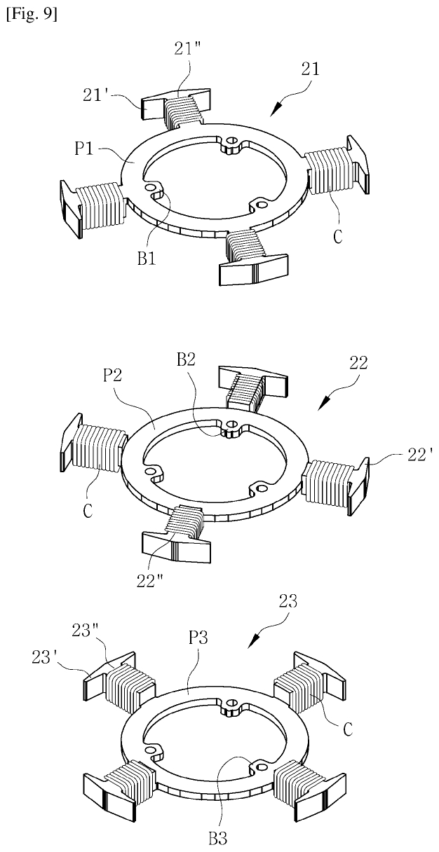

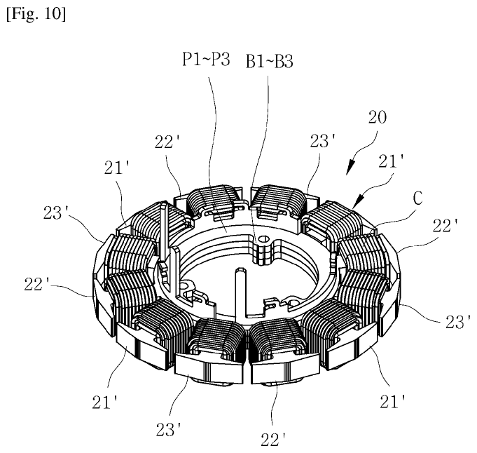

FIG. 9 is an exploded perspective view illustrating a stator assembly according to the present invention. FIG. 10 is a perspective view illustrating a stator assembly according to the present invention. According to FIG. 9, the stator assembly 20 may be provided by assembling the first to third segmented laminated cores 21, 22, 23 as illustrated in FIG. 10, by having the plurality of teeth 21′, 22′, 23′ of each of the first to third segmented laminated cores 21, 22, 23 protruded at equal intervals, winding an aluminum coil C on the neck parts 21″, 22″, 23″ of the respective teeth 21′, 22′, 23′, and then disposing the teeth 22′, 23′ of the second segmented laminated core 22 and the third segmented laminated core 23 between the teeth 21′ of the first segmented laminated core 21. In the drawings, P1, P2, P3 are circular bases of the first to third segmented laminated cores 21, 22, 23, respectively, and B1, B2, B3 are protrusions with assembly holes protruding inwardly of the first to third segmented laminated cores 21, 22, 23, respectively.

In assembling the first to third segmented laminated cores 21, 22, 23, an aluminum coil C is wound on each neck part 21″, 22″, 23″, and accordingly, it is possible to wind a coil C having a larger number of turns, thereby increasing the efficiency of magnetic field generation. Of course, in order to wind the aluminum coil C, the neck parts 21″, 22″, 23″ of the first to third segmented laminated cores 21, 22, 23 are insulated by bonding an insulating coating or an insulator made of an insulating material on the surface thereof.

As illustrated in FIGS. 4 and 6, a plurality of heat dissipating parts 211 are formed at regular intervals in the transverse direction on an upper part and a lower part of the molding 210 enclosing the stator assembly 20 to dissipate the heat generated inside the motor assembly 200. The plurality of heat dissipating parts 211 formed on the molding 210 have the outer side open and form a heat dissipating space S of a ‘V’ shape in which the inner side is narrow and the outer side is wide, so that the heat generated inside the aluminum coil C wound on each of the first to third segmented laminated cores 21, 22, 23 is dissipated to the outer open side of the heat dissipating space S of the heat dissipating part 211, thereby cooling the motor assembly 200 and greatly improving the performance of the motor. The heat released outside the heat dissipating space S is discharged to the outside through a heat discharging hole 13A in the rotor housing 13.

When viewed in a plan view, the heat dissipating space S of a ‘V’ shape in which the inner side is narrow and the outer side is wide is open to the outside, so that the heat generated inside the motor M does not stagnate inside the heat dissipating space S but is discharged smoothly, resulting in heat diffusion dissipation, thereby improving rapid heat dissipating efficiency. In addition, a ‘V’ shaped groove is formed by penetrating in the axial direction, thereby having a structure for effective heat dissipation.

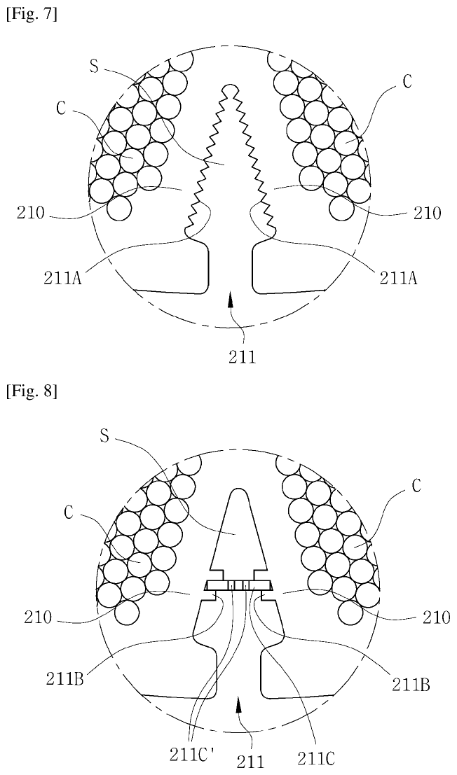

FIG. 7 is a cross-sectional view illustrating an excerpted portion of another embodiment of a motor assembly of an engine cooling fan motor for a vehicle according to the present invention. Referring to FIG. 7, a concaved-shape heat dissipating protrusion 211A protrudes longitudinally on both inner sides of the heat dissipating space S of each of the plurality of the dissipating parts 211 formed on the molding 210, so that the heat generated inside the motor M comes into contact with the heat dissipating protrusion 211A, which broadens the contact area of the heat, thereby improving heat dissipation efficiency.

FIG. 8 is a cross-sectional view illustrating an excerpted portion of yet another embodiment of a motor assembly of an engine cooling fan motor for a vehicle according to the present invention. As illustrated in FIG. 8, an aluminum heat dissipating plate 211C having a plurality of heat dissipating holes 211C′ is axially inserted into a guide rail 211B axially formed on both inner sides of the heat dissipating space S of each of the plurality of heat dissipating parts 211 formed on the molding 210, so that the heat inside the motor released into the heat dissipating space S is absorbed and released by the aluminum heat dissipating plate 211C, thereby quickly increasing the heat dissipation efficiency.

It should be noted that the description of the present invention described above is merely an example for understanding the present invention, and is not intended to limit the scope of the present invention. It should be construed that the scope of the present invention is defined by the appended claims, and all modifications and alternations of the present invention fall within the protection scope of the present invention.

1. An engine cooling fan motor for a vehicle, comprising:
an upper housing 100 having a PCB 110 housed therein; and
a motor assembly 200 comprising a rotor assembly 10 coupled to a shaft 11 rotating through an upper bearing 11A and a lower bearing 11B, comprising a rotor housing 13 provided with a plurality of magnets 12 along an inner periphery; and a stator assembly 20 assisting the rotation of the rotor assembly 10;
wherein the stator assembly 20 is insert injected with a resin to enclose the stator assembly 20 with a molding 210, and a plurality of heat dissipating parts 211 are formed at regular intervals in the transverse direction on an upper part and a lower part of the molding 210 to dissipate the heat generated inside the stator assembly 20.

2. The engine cooling fan motor for a vehicle of claim 1, wherein the molding 210 is molded with a resin on an upper part, lower part, inner side and outer side of an aluminum coil C including the teeth 21′, 22′, 23′ of each of the first to third segmented laminated cores 21, 22, 23.

3. The engine cooling fan motor for a vehicle of claim 1, wherein the molding 210 has a plurality of heat dissipating parts 211 which have the outer side open and form a heat dissipating space S of a ‘V’ shape in which the inner side is narrow and the outer side is wide.

4. The engine cooling fan motor for a vehicle of claim 1, wherein a concaved-shape heat dissipating protrusion 211A protrudes longitudinally on both inner sides of the heat dissipating space S of each of the plurality of the dissipating parts 211 formed on the molding 210.

5. The engine cooling fan motor for a vehicle of claim 1, wherein an aluminum heat dissipating plate 211C having a plurality of heat dissipating holes 211C′ is axially inserted into a guide rail 211B axially formed on both inner sides of the heat dissipating space S of each of the plurality of heat dissipating parts 211 formed on the molding 210.

6. The engine cooling fan motor for a vehicle of claim 1, wherein the stator assembly 20 is assembled by winding an aluminum coil C on each neck part 21″, 22″, 23″ of the first to third segmented laminated cores 21, 22, 23 in which a plurality of teeth 21′, 22′, 23′ are protruded at equal intervals.
